(19) United States
(12) Patent Application Publication
(10) Pub. No.: US 2024/0210969 A1
(43) Pub. Date: Jun. 27, 2024

(54) COMPACT FIELD CALIBRATABLE PRESSURE REDUCING VALVE

(71) Applicant: Giacomini S.P.A., San Maurizio d'Opaglio (NOVARA) (IT)

(72) Inventors: Giuliano RUGA, San Maurizio d'Opaglio (IT); Andrea SGARIA, San Maurizio d'Opaglio (IT)

(73) Assignee: Giacomini S.P.A., San Maurizio d'Opaglio (NOVARA) (IT)

(21) Appl. No.: 18/556,826

(22) PCT Filed: Nov. 5, 2021
(86) PCT No.: PCT/IB2022/053766

§ 371 Date: Oct. 23, 2023

(30) Foreign Application Priority Data
Apr. 23, 2021 (IT) 102021000010403

(51) Int. Cl. G05D 16/10; F16K 17/04

(52) U.S. Cl. CPC G05D 16/10; F16K 17/048

(57) ABSTRACT

A compact field calibratable pressure reducing valve for fire-fighting systems includes a valve body provided with an inlet opening and an outlet opening, a shutter assembly slidingly arranged within said body and comprising a first stem portion connected at one end with a shutter and a second stem portion slidingly and rotatably arranged with one end connected to said piston and a second end extending outside said body and suitable for connection with a handwheel; a compression assembly comprising a compression elastic member and an adjustment ferrule for compressing said compression elastic member so as to exert a force on said piston. Said elastic compression member includes a plurality of disc springs axially stacked in a stack on said second stem portion between said piston and said adjustment ferrule.

### FIELD OF THE TECHNIQUE

The present invention relates to a compact field calibratable pressure reducing valve. More particularly, the present invention relates to a novel pressure regulating valve of the Pressure Reducing Valve type, of compact size and field calibratable, i.e. when arranged in place, typically but not limitedly for use in fire-fighting systems.

### STATE OF THE ART

Hydraulic water pressure reducing valves or devices are widely known and used, particularly in the fire-fighting protection systems sector, constructively they are straight globe and angle valves (as per NFPA14 standard), provided with means of manual field adjustment of the downstream pressure, either as dynamic pressure in the presence of flow or residual pressure or static pressure in the absence of flow.

These well-known types of valves are advantageously used in fire-fighting systems because they allow the water pressure to the connecting hoses of hydrants or other fire extinguishing systems, such as sprinklers, to be kept under control regardless of the static or residual pressure of the upstream supply.

For example, in a traditional fixed fire-fighting system in a multi-storey building, both the static and residual pressure of the supply arriving at the fire-fighting connection boxes on each floor will gradually decrease as the height or pressure head at which the floor of the building is located increases. The static and residual operating pressures of the system on the lower floors will therefore always be higher than the operating pressures on the upper floors.

The residual pressure adjustment at the valve outlet can be pre-set, allowing the valve to maintain constant outlet pressures as the elevation of the utilization changes in such a way to ensure that the correct required pressure is provided to each floor.

Pressure Reducing Valves also have the task of limiting downstream pressure even under non-flow and static pressure conditions, typically below 12 bar. This pressure control occurs through a pressure-controlled chamber inside the valve, otherwise the pressure reduction is not adjustable, but defined by the valve geometry itself.

Manual residual pressure adjustment can be instead performed directly on field, by means of tools or wrenches, depending on the available upstream pressure of the valve itself. These types of valves are generally classified according to how the pressure is adjusted and whether or not such adjustment is possible on field once installation.

In order to control the static and dynamic water pressures prescribed by design, these well-known types of fire valves are provided with elastic counter elements typically consisting of preloaded coil springs coaxially arranged to the plug stem.

The spring is preloaded in such a way that even when the valve is opened by acting on the handwheel or knob, the valve plug will remain closed until the outlet water pressure has reached a value equal to or less than the force required to overcome the spring resistance and lift the valve plug to open.

The reduction valves described above are specific valves for applications on fire-fighting systems that operate with very high flow rates and hydraulic fluid pressures, generally about an order of magnitude higher than the classic balancing valves used in other thermal field applications, said fluid flow rates typically about of 500 gpm (gallons per minute) equivalent to about 113 m3/h (cubic meters per hour) with inlet pressures about of 500 psi (pounds per square inch) equivalent to about 34 bar. However, the safety factor required for certifications of these valves by UL/FM certifying authorities is 5 times, or about 170 bar. A typical example of these types of pressure regulating valves are the well-known pressure reducing valves type, calibratable on field, manufactured by the Applicant in the series named A201, A202, A203, A204 (see Giacomini S.p.A. Product Catalogue, web address: https://www.giacomini.com/en/products/hose-sprinkler-valves-and-accessories).

However, these types of field calibratable Pressure Reducing Valves have some operational limits.

A typical limitation of these well-known types of valves particularly perceived in fire-fighting systems, is that the coil springs have considerably large dimension relative to the valve body, especially in length, and such as to allows the valve itself to operate at high pressure ranges, typical of fire-fighting systems. The distance between spring coils also must be such as to ensure that the spring can be preloaded over in a range of variable forces necessary to counteract the variable pressure of the water, thus necessarily making the coil spring bulky in length.

This limitation implies that field calibratable fire-fighting pressure reducing valves necessarily have large constructive overall dimensions, especially in the height dimension, in order to accommodate the coil springs, overall dimensions such that make valve installation in a traditional fire-fighting box difficult if not impossible.

The problem of how to reduce the overall dimensions of these well-known types of valves is particularly required in the state of the art.

A further limitation of these well-known types of valves is due to the fact that they are not easily adjustable at high flow rates and high outlet pressures as shown by diagrams in FIG. 5 regarding control curves at different preloads of traditional Giacomini S.p.A. flat control valves (mod, A203, A 204).

A solution aimed to limiting overall height dimensions is described in U.S. Pat. No. 7,320,333 (B2) referring to a field adjustable pressure reducing valve, suitable for connection to a water supply line, which includes a valve body with an inlet for connection to the pressurized water supply line, an outlet, a passage extending between the inlet and outlet and a valve seat. A valve stem provided with a sealing element is disposed in said passageway. An automatic pressure reduction system is provided to push the sealing element toward the valve seat so as to close the passageway to reduce pressure to the outlet. The automatic pressure reducing system includes helical springs arranged in parallel in such a way as to occupy less space for a given spring load than conventional springs.

A further limitation of these well-known types of valves is also due to the fact that it is not possible to easily vary the spring stiffness by varying the working range of the valve, creating new models or developing existing models, without necessarily varying characteristics and dimensions of the compression coil springs.

However, the technical solution in U.S. Pat. No. 7,320,333 (B2), while providing more compact dimensions, does not confer advantages in terms of pressure regulation.

### SCOPE OF THE INVENTION

It is scope of the present invention to overcome and obviate, at least in part, the above-mentioned drawbacks and operational limitations.

More particularly, it is scope of the present invention to provide a field calibratable pressure reducing valve, i.e., once arranged in place, small and compact in size compared to known art valves and such that it can be easily operated and calibrated/adjusted by the user once installed inside a conventional fire-fighting box in very limited space.

A further scope of the present invention is to provide a compact field calibratable pressure reducing valve capable of being manufactured in modular families or series such that it can be operate over different pressure ranges while maintaining the same external overall dimensions of the valve, or of its adjusting portion, even in valve models suitable for operating over higher pressure ranges without having to increase proportionately its overall dimensions.

Not least scope of the present invention is to provide a compact field calibratable pressure reducing valve with improved control capability at high flow rates and high outlet pressures. Further scope still of the present invention is to provide a compact, field calibratable pressure reducing valve capable of a high level of mechanic strength and reliability over time, such that it can be easily and economically manufactured.

These and other scope are achieved by the compact field calibratable pressure reducing valve of the present invention in accordance with the independent claim.

The constructional and functional features of the compact field calibratable pressure reducing valve may be better understood from the detailed description below, in which reference is made to the attached drawings representing some preferred and non-limiting embodiments in which:

### BRIEF DESCRIPTION OF THE FIGURES

FIG. 1 is a schematic representation of an axonometric and exploded perspective view of a preferred embodiment form of the compact field calibratable pressure reducing valve of the present invention;

FIG. 2 is a schematic representation of a longitudinal sectional view of the compact field calibratable pressure reducing valve of the subject invention;

FIG. 3 is a schematic representation of a side view in the direction of the outlet opening of the compact field calibratable pressure reducing valve of the subject invention;

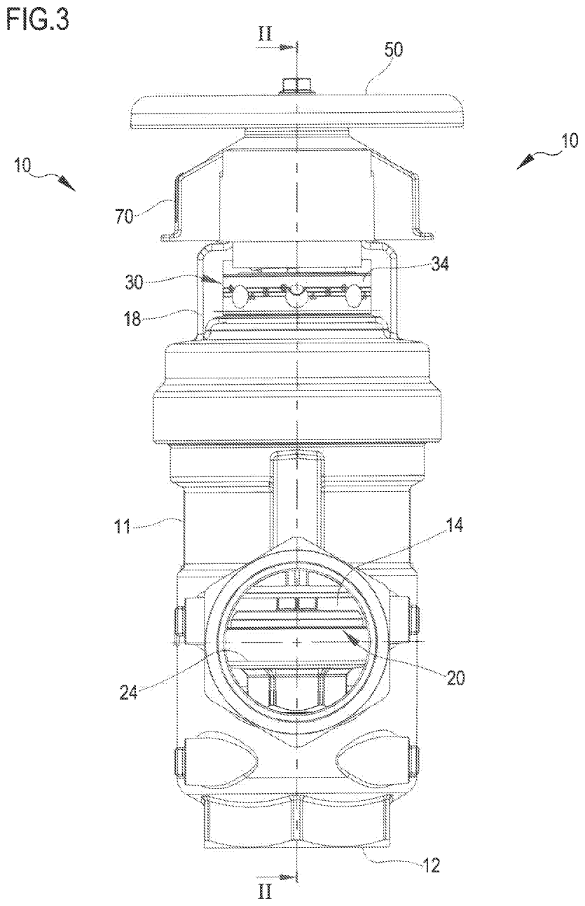

FIGS. 4a and 4b are schematic representations of comparisons, at the same scale, of longitudinal cross-sectional views of a compact pressure reducing valve calibratable to the field of FIG. 4a in comparison with a homologous pressure reducing valve according to the known art of FIG. 4b;

FIG. 5 is a representation of the graphs of the control curves of three conventional Giacomini S.p.A. valves (mod. A202, A204) sized for flow rates of 300, 350 and 400 gpm, at different spring preloads, with the inlet pressure in abscissa and the outlet pressure in ordinate at different preloads, with highlighted in the box with angled hatching the field with high outlet pressures difficult to reach by the control curves.

### DETAILED DESCRIPTION OF THE INVENTION

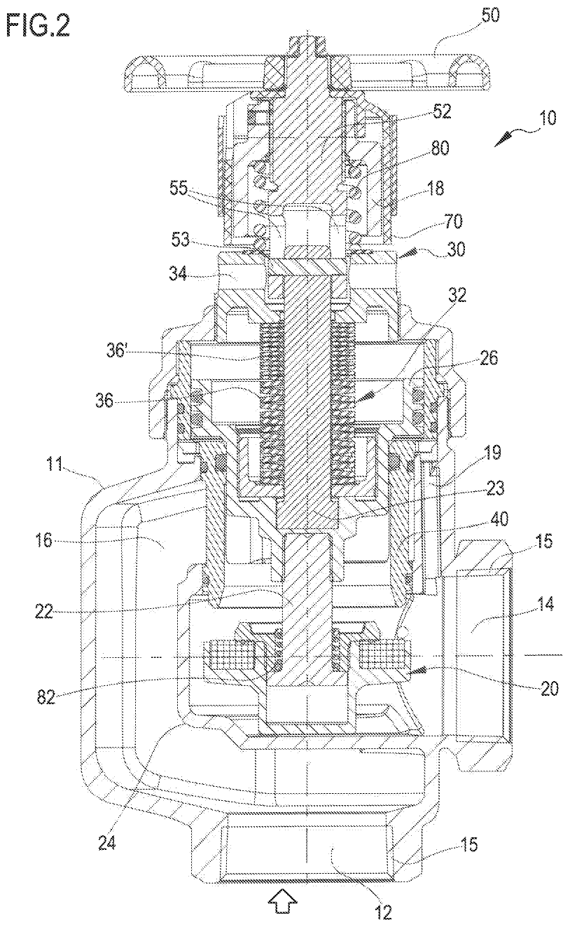

With reference to figures and in particular FIG. 2, there is hereinafter described in a preferred embodiment, given for illustrative and non-limiting purposes, a compact field calibratable pressure reducing valve of the present invention, indicated with the reference number 10.

The compact field calibratable pressure reducing valve 10 includes:
a valve body 11 provided with an inlet opening 12 and an outlet opening 14 provided with known hydraulic connecting means 15 and an inner chamber 16 adapted to place in fluid connection said inlet opening 12 and said outlet opening 14;
a shutter assembly 20 slidingly disposed inside said body 11 and comprising a first stem portion 22 connected at one end with a shutter 24 suitable to close the flow of water between said inlet opening 12 and said outlet opening 14 inside said inner chamber 16, said first stem portion 22 being integral at the other end with a piston 26 slidingly disposed inside said body 11 with a portion of surface exposed in fluid contact with said inlet opening 12 and with a portion of annular surface exposed in fluid contact with said inlet opening 14; a second stem portion 23 slidingly disposed with one end connected to said piston 26 and a second end extended outside said body 11 and adapted to be connected with a handwheel 50;
a compression assembly 30 comprising a compression elastic member 32 and an adjustment ferrule 34 slidingly disposed with respect to said second portion of rod 23 in body 11, said adjustment ferrule 34 being adapted to compress said compression elastic member 32 by preloading it axially with respect to said second portion of rod 23 against said piston 26 in such a way as to counteract the pressure of water at outlet opening 14 and to regulate the movement of shutter 24.

Said valve 10 has the novel feature of an elastic compression member 32 comprising a plurality of disc springs 36, 36′ also known as conical washer springs or Belleville springs, said disc springs 36, 36′ being axially arranged in a stack on said second stem portion 23 between said piston 26 and said adjustment ferrule 34.

Said plug 24 is slidingly disposed in axial direction in said body 11 integral with the first stem portion 22 placed in connection with piston 26 and said second stem portion 23 slidingly rotatable and operable by a handwheel 50 by means of a threaded coupling with a bell 18 fixed to body 11 of valve 10.

Said plurality of disc springs 36, 36′ have a traditional concave discoidal washer shape with a truncated cone development where each disc spring is configured to be elastically loaded in the axial direction. With reference still to the preferred embodiment form of FIG. 2, said disc springs 36, 36′ are advantageously arranged in a stack at their central opening on the outer diameter of said second stem portion 23.

Said elastic compression member 32 comprising a plurality of disc springs 36, 36′ may also advantageously be defined by stacking each or groups of disc springs 36, 36′ with concavity in a concordant or opposite direction so as to obtain an elastic characteristic analogous to a conventional coiled compression spring or obtain an ideal design characteristic for the valve type and pressure ranges of valve operation.

Said elastic compression member 32 may also advantageously comprise two or more packs or stacks of disc springs arranged in series, said packs or stacks being formed of a first type of disc spring 36 and a second type of disc spring 36′ having different geometric and elastic characteristics.

A different stacking arrangement of the disc springs 36, 36′ allows the compression spring member 32 to absorb high compressive loads in a reduced housing space and bulk in both axial and radial directions compared to a conventional coiled compression spring.

A different configuration of the disc spring arrangement 36, 36′ allows the compression spring member 32 to achieve characteristic load and stroke curves of both linear and digressive or progressive types. By arranging said plurality of disc springs 36, 36′ or two or more stacked groups of them in series, arranged with alternating opposite concavity of the discs in the axial direction, as in the preferred embodiment of FIG. 2, or arranged partially with concordant concavity (in a variant form), it is indeed possible to advantageously obtain in a limited space the characteristics equivalent to conventional coil springs arranged in series, in the case of springs with alternating opposite concavity or equivalent to traditional coil springs concentrically arranged in parallel, as in the known embodiment of the prior art described in U.S. Pat. No. 7,320,333 (B2).

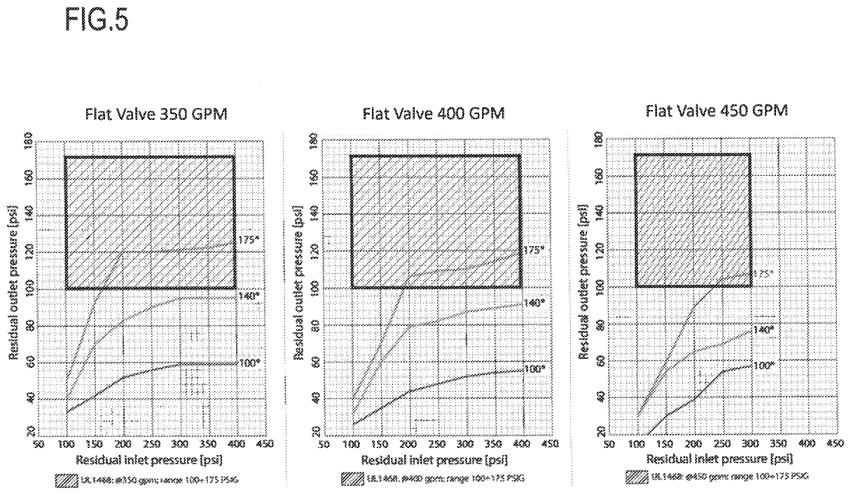

With particular reference to the diagrams of FIG. 5, the arrangement of the plurality of disc springs 36, 36′, stacked in two or more groups of them in series, arranged with alternating opposite concavity of the discs in the axial direction, makes it possible to better configure and draw the control curves of valves sized for high flow rates where for low pressures work the less rigid disc springs 36, 36′ with greater displacement, allowing the regulation curves to cover the lower part of the diagrams in FIG. 5 (indicatively, the non-working range), while for high pressures the disc springs 36, 36′ work more rigidly and allow, with their more limited deformation and displacement, the regulation curves to advantageously cover the upper part highlighted in the box of the diagrams in FIG. 5 with high outlet pressures.

By varying for each group or stack of disc springs 36, 36′ the number or geometric characteristic of the discs, diameter and thickness, as well as the direction of stacking, variable stiffness values can be obtained depending on the compression.

Disc springs 36, 36′ also have further additional advantageous features compared to conventional coiled compression springs such as a low tendency to plastic deformation and elastic relaxation and a concentrically distributed load compared whit a coiled compression spring.

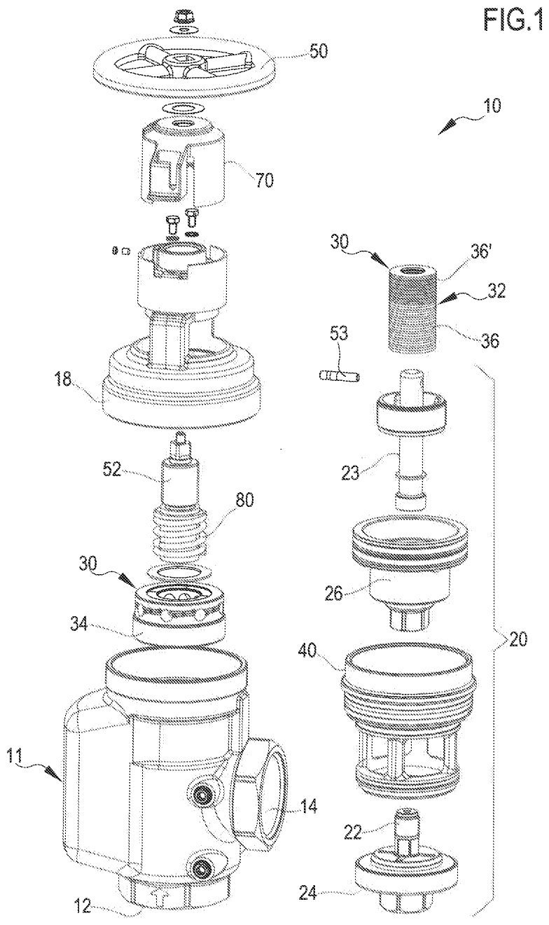

With special reference to FIGS. 1 and 2, said compression spring member 32 may also comprise, as mentioned above, a plurality of a second type of disc springs 36′, arranged in stacks, different from a plurality of a first type of disc springs 36′, having different geometric characteristics with respect to each other, such as a different thickness in order to be able to modulate the value of the elastic constant more widely, so as to maximize the elastic force obtainable in a reduced compression space in the axial direction.

Said disc springs 36, 36′ are generally made of steel but can also be made of other materials having similar elasticity and strength.

Said valve body 11 and bell 18 are typically made of brass alloys for hydraulic use but may also be made of any oxidation resistant metal or polymeric plastic materials.

In the embodiment of the figures, given for illustrative and non-limiting purposes only, the inlet opening 12 is arranged at an angle of 90° with respect to the outlet opening 14, however in further possible alternative embodiments the inlet and outlet openings may also be arranged on the same axis at an angle of 180° or in intermediate positions.

Said hydraulic connection means 15 may be conventional male or female threads formed on the valve body at said inlet and outlet openings 12, 14 or other known types of male or female hydraulic connections such as fast couplings, fittings or equivalents.

Said disc springs 36, 36′ may also have in further variant embodiments, in addition to different thicknesses and diameters, shapes and profiles typical of known washers such as, for example, wave washer, tooth washer etc., having different mechanical behaviours.

Still, in the preferred embodiment of the figures, said shutter assembly with piston 26 and elastic compression member 32 can be slidingly arranged directly in body 11 of valve 10 or inside a lantern sleeve 40 defining a detachable cartridge assembly with respect to body 11 of valve 10.

In the preferred embodiment of the figures, the shutter assembly 20 is further configured to close the passage of water by translating in the direction opposite to the direction of passage of water from the inlet opening 12 to the outlet opening 14 but, in a variant embodiment, may be configured to close the passage of water by translating in the same direction as the passage of water.

From the description of the compact field calibratable pressure reducing valve 10 of the present invention, its operation described below is evident.

With reference to the figures and in particular FIG. 2, the compact field calibratable pressure reducing valve 10 of the present invention operates analogously to a conventional compact field calibratable pressure reducing valve according to the known art.

Referring only to FIG. 2, acting on the operating handwheel 50 brings into rotation a rod 52 connected directly or indirectly at one end to said second stem portion 23 by means of a cylindrical pin 53 and connected to the handwheel 50 by means of a nut tightened on the opposite end of the rod 52.

Said rod 52 is screwed into the conjugate thread of said bell 18 transmitting axial motion to said second stem portion 23 only when rod 52 moves by screwing upwardly (as in the configuration of FIG. 2) because pin 53, being slidingly disposed in rod 52, can translate through vertical slots 55.

The upward axial movement of the second stem portion 23 in an axial direction leads the piston 26 and the second stem portion 22 upward, leading the shutter assembly 20 with the shutter 24 to close the passage within the chamber 16 of the body 11 by connecting the inlet opening 12 with the outlet opening 14 in a fluid connection.

When, on the other hand, the rod 52 is screwed sliding downwardly, the shutter assembly 20 with the first stem portion 22, the piston 26 and the second stem portion 23, connected together, can float freely translating in the axial direction, in such a way that the opening or closing of the shutter assembly 20 is not controlled by the position of the handwheel 50 but by the balance between the pressure force of the outgoing water (acting on a portion of the piston) and the elastic force of the compression of the spring member 32 with the disc springs 36, 36′.

The water pressure at the outlet opening 14, arriving through a passage 19 formed in the body 11, applies a pressure force on the exposed surface of the piston 26 counteracted by the force from the elastic compression member 32.

When the water pressure reaches a value such as to overcome the force of the elastic compression member 32, the piston 26, together with the shutter assembly 20, translates to close the passage of water between the inlet opening 12 and the outlet opening 14.

Reducing the water passage cross-section through the same half-closed shutter assembly 20 results in an additional pressure drop, i.e., a reduction in water pressure at the outlet opening 14 outlet, thereby allowing the piston 26 and the shutter assembly 20 to converge to a balance position.

The resistance of the elastic member 32 to the water pressure at the outlet opening 14 can be increased by loading and unloading the elastic compression member acting on the piston 26 in a direction opposite to the pressure force, by operating on the compression assembly 30 by screwing and unscrewing the adjustment ferrule 34 which slides in an axial direction with respect to the second stem portion 23 by compressing or decompressing the disc springs 36, 36′ of the elastic compression member 32.

Said adjustment ferrule 34 is typically provided with a plurality of holes or openings on its exposed surface suitable for housing a rod (not shown) in order to apply the rotational torque for adjustment. Said adjustment may be performed with any other type of tool or wrench acting on a conjugate profile formed on the outer surface of said adjustment ferrule 34 such as a conventional hexagon wrench.

With reference to the figures, the valve 10 can also be provided with a striker element 70 having a socket shape and capable of axially translating in solidarity with the handwheel 50 and the rod 52, said striker element 70 being capable of looking at reference means (not shown), which can be stamped or shown on the same striker element 70 or, in alternative forms on the bell 18 or other elements, in such a way as to visually indicate to the user the operating status of the valve, open or closed.

With reference still to the same figures and in particular to FIG. 2, in a preferred embodiment the valve 10 can be provided with a traditional first coil spring 80 arranged on the handwheel operating end 50 between the body 11 and the adjustment ferrule 34, said latter being connected to the body 11 through a threaded coupling. Said first coil spring 80 has no influence on the closing and opening of the shutter 24 and is designed to press on the adjustment ferrule 34 in the opposite direction to the set of disc springs 36, 36′ of the elastic compression member 32, in such a way as to make the setting operation easier, by lightening the manoeuvring torque needed to move the same adjustment ferrule 34.

With special reference again to FIG. 2, in an embodiment of valve 10, the shutter assembly 20 may comprise a traditional second coil spring 82 housed between the first stem portion 22 and the shutter 24, said shutters being slidingly arranged one with respect to the other. Said second coil spring 82 is configured to push the shutter 24 causing it to translate with respect to the first portion of the stem 22, tending to close said shutter 24 when it is at rest, where by gravity the same would tend to remain open. This arrangement defines a water non-return system in case the outlet pressure is higher than the inlet pressure.

Said adjustment ferrule 34 of the compression assembly 30 may also advantageously be protected by a safety cover (not shown) to prevent tampering with the adjustment of the elastic compression member 32.

In the preferred embodiment of the valve 10 shown in the figures, the closing of the shutter 24 of the shutter assembly 20 is accomplished by a translation in a direction opposite to the direction of passage of water from the inlet opening 12 to the outlet opening 14.

The described invention however, in an alternative variant embodiment, may function mutatis mutandis in the same way in the opposite configuration, wherein the closure of the shutter of the shutter assembly occurs with a translation in a direction concordant with the direction of passage of water from the inlet opening 12 towards the outlet opening 14.

However, the first preferred embodiment configuration is further advantageous since the inlet pressure acts simultaneously and oppositely on the top face of the shutter 20 and on the exposed surface of the piston 26, making the closing mechanism of the shutter assembly less sensitive to said inlet pressure, i.e. more dependent on the outlet pressure alone which determines the operation of the valve 10.

As can be seen from the foregoing, the advantages that the compact field calibratable pressure reducing valve of the present invention achieves are obvious.

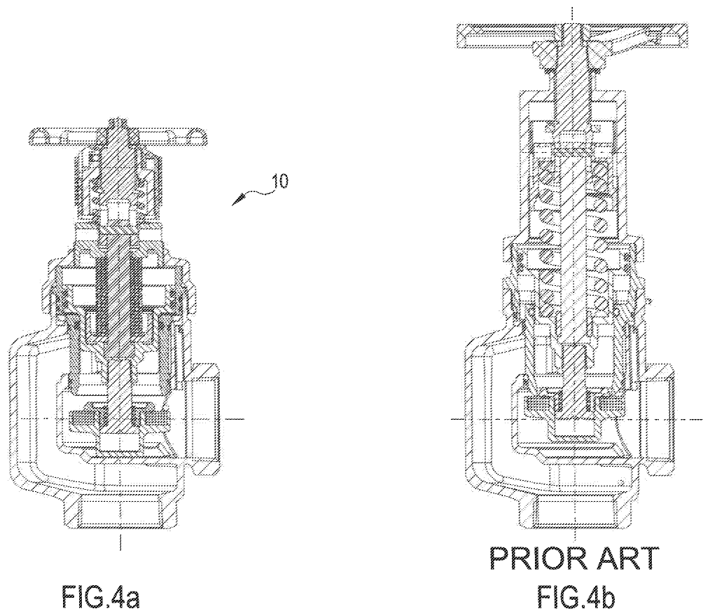

The compact field calibratable pressure reducing valve 10 of the present invention is particularly advantageous because it allows to provide the user with a device of sensibly reduced overall dimensions with respect to the known art, as from the comparison of FIGS. 4a and 4b, thanks to the elastic compression member 32 able to guarantee the same elastic operating forces of a traditional coil spring in a sensibly smaller displacement space along the axis.

A further advantage of the compact field calibratable pressure reducing valve 10 of the present invention is that it is possible to stack disc springs 36, 36′ differently in order to change the spring constant stiffness or stroke of the stack of disc springs obtaining an overall stiffness constant analogous to a corresponding equivalent spring or to a plurality of spiral springs concentrically arranged in parallel, for example by stacking some disc springs 36 in a concordant direction thus obtaining a reduced bulk of the compression spring member 32 and consequently of the valve also in the direction radial to the axis of the same compression spring element.

A further advantage of the compact, field calibratable pressure reducing valve 10 is that it is also possible to use disc springs 36, 36′ of different thicknesses and shapes in order to have a wide range of modularity and to achieve any value of elastic constant or stiffness of the elastic compression member 32, in such a way as to be able to obtain values of stiffness and resulting spring rate that can be designed specifically for the type of use, being able to obtain an infinite number of values of the elastic constant or spring rate with a reduced valve space 10.

Although the invention has been described above with particular reference to a preferred embodiment, given for illustrative and non-limiting purposes, numerous modifications and variations will become obvious to a skilled person in the light of the above description. The present invention, therefore, is intended to encompass all modifications and variations falling within the scope of protection of the following claims.

1. A field calibratable pressure reducing valve for fire-fighting systems, the valve comprising:
a valve body having an inlet opening and an outlet opening, said inlet opening and said outlet opening including hydraulic connection means, said valve body comprising an inner chamber configured to be placed in fluid connection with said inlet opening and said outlet opening;
a shutter assembly slidingly disposed inside said valve body and including a first stem portion connected at a first end with a shutter configured to prevent flow between said inlet opening and said outlet opening inside said inner chamber, said first stem portion being integral, in correspondence by a second end, with a piston that is slidingly disposed inside said valve body and having a first surface in fluid contact with said inlet opening and having a second surface in fluid contact with said outlet opening, said shutter assembly further comprising a second stem portion that is slidingly and rotatably arranged with one end connected to said piston, and a second end extended outside said body and configured to be connected with a handwheel;
a compression assembly comprising an elastic compression member and an adjustment ferrule that is slidingly disposed with respect to said second stem portion and configured to compress said elastic compression member in such a way as to exert a force on said piston;
wherein said elastic compression member comprises a plurality of disc springs that are axially arranged in a stack on said second stem portion between said piston and said adjustment ferrule.

2. The valve according to claim 1, wherein the shutter is slidingly disposed in an axial direction in said valve body integral with the first stem portion and in connection with the piston, and the second stem portion rotatably sliding and operable by the handwheel by means of a threaded coupling with a bell attached to the valve body.

3. The valve according to claim 1, wherein said plurality of disc springs have a concave discoidal washer shape with a truncated cone development.

4. The valve according to claim 3, wherein said elastic compression member is defined by arranging groups of the plurality of disc springs so that concavity associated with the concave discoidal washer shape is arranged in a concordant or opposite direction so as to obtain an elastic characteristic of a coiled compression spring.

5. The valve according to claim 4, wherein said elastic compression member comprises two or more packs of disc springs arranged in series, wherein said packs of disc springs are formed by a first type of disc springs and a second type of disc springs having different geometric and elastic characteristics.

6. The valve according to claim 1, wherein said shutter assembly is configured to prevent passage of water by translating in a direction opposite to the direction of passage of water from said inlet opening to said outlet opening.

7. The valve according to claim 1, wherein said shutter assembly is configured to prevent the passage of water by translating in a direction concordant with the direction of passage of water from said inlet opening to said outlet opening.
